(19) United States
(12) Patent Application Publication
(10) Pub. No.: US 2003/0135557 A1
(43) Pub. Date: Jul. 17, 2003

(54) Distributed revision block service

(75) Inventor: Kenneth L. Davis, San Diego, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/044,698

(22) Filed: Jan. 11, 2002

(51) Int. Cl. G06F 15/16; G06F 17/00

(52) U.S. Cl. 709/206; 707/104.1

(57) ABSTRACT

One or more embodiments of the invention provide a method, apparatus, and article of manufacture for distributing design document changes. A representation (e.g., an extensible markup language [XML] representation) of a revision block of a design document is captured. The revision block documents a history of changes to the design document. Once captured, the representation is distributed via a network service to consumers, document management utilities, and/or a database.

### BACKGROUND OF THE INVENTION

1. Field of the Invention.

The present invention relates generally to changes to a design document, and in particular, to a method, apparatus, and article of manufacture for capturing and distributing a representation of a revision block (comprising changes) for a design document.

2. Description of the Related Art.

Electronic design documents (e.g., drawings, blueprints, etc.) ate often shared by multiple users that collaborate together on a project. However, when multiple collaborators are editing a document at different locations, the prior art does not provide a simple, efficient, and expeditious method for ensuring that all collaborators are utilizing the same version of a document and are aware of changes made by other users. These problems may be better understood by describing design documents and prior art methods utilized to ensure proper collaboration.

Design documents such as drawings, blueprints, solid models, etc. are created and frequently used in a variety of industries today. Electronic versions of such documents may be created using various applications such as computer aided design (CAD) applications, parametric modeling applications, etc. In addition to single users creating and utilizing design documents, participants in a project (e.g., organizations, architectural/design firms, construction companies, contractors, etc.) often collaborate together and/or work on or off of the same electronic version of a design document. However, since the collaborators are often in different locations, it is difficult to ensure that each user is aware of changes made by other users so that each collaborator can take other collaborator's work into account (e.g., to ensure that work is not duplicative or inapposite). Additionally, it is difficult for one of the collaborators to easily determine which version of a design document is being viewed/used and the history of changes to that document.

To indicate the version of a particular document, revision blocks may be used. A design document and included revision block are illustrated in FIG. 1A. A larger version of the revision block of FIG. 1A is illustrated in FIG. 1B. Revision blocks 100 are used to document the history of changes to a design document 102. Usually the blocks 100 are a table of various design document 102 properties such as a revision number 104, a description 106, a user name 108, and date 110. Additionally, properties such as changed by, approved by, etc. may be included in a revision block 100. These properties may be customized to meet the documentation needs of varying organizations. Thus, all revisions are noted in a revision block 100 and are dated and identified by various properties. To enable a user to quickly identify and utilize the revision information, the revision block 100 is often placed/displayed in the upper right corner of a design document 102.

Traditionally, revision blocks 100 are placed in a design document 102 and updated each time the document 102 is revised. Accordingly, the prior art mechanism for collaborating with another user regarding document 102 changes (e.g., to notify other users that a document 102 has been changed) is to email or transfer (e.g., by facsimile) an entire design document 102/drawing file including changes and the revision block 100 to another user. Thereafter, the recipient of the transmission must open the design document 102 to view the revision block 100 and changes in the document 102. For example, a user may make changes to a drawing 102 on one computer (at which time a revision block 100 may be updated) and then email or transfer the changed drawing 102 (with the stored revision block 100) to another user. The receiving user must then open the document 102 to determine what changes were made. In addition to having to open a file to determine changes, graphic files involved in CAD applications and models are often very large. Accordingly, such a transmission mechanism is slow, time consuming, and inefficient.

Thus, the prior art provides for transmitting the entire design document 102 to collaborators in varying disparate locations. The disparate locations may be located anywhere in the world and the design document may be transmitted to them in various forms using the Internet. The Internet is widely utilized to transmit and receive information in the form of web pages that are translated/interpreted and displayed by a web browser on a computer.

So that a browser can interpret and display a web page, document definition languages and standard programming languages are utilized to define the web page. For example, hypertext markup language (HTML) is widely used to define web pages. However, HTML utilizes a predefined set of “tags” to describe elements on the web page. As a result, extensible markup language (XML) has become and is becoming more widely used on the Internet because XML is more flexible than HTML and allows tags to be defined by the developer of the web page. Thus, tags for virtually any data items such as a product, sales representative, and or amounts due, can be used for specific applications, allowing web pages to function like database records.

Accordingly, revision blocks 100 are stored with a design document 102 and are updated when the document 102 is updated. To notify other users/collaborators of the update and the change, the entire document 102 must be forwarded across a network to the collaborator where it must be opened to determine the changes (e.g., by viewing the revision block 100 within the design document 102). Such a process is inefficient, slow, and requires multiple actions by the user.

### SUMMARY OF THE INVENTION

Revision blocks are used to document the history of changes to a design document. Traditionally, revision blocks are placed on a design document and updated each time the document is revised. One or more embodiments of the invention provide a distributed revision block service that automatically captures a representation (e.g., an XML representation) of a design document's revision block and distributes it to a variety of consumers via a web service. Further, as additional revisions are added to the revision block, the service updates the representation and redistributes it.

### BRIEF DESCRIPTION OF THE DRAWINGS

Referring now to the drawings in which like reference numbers represent corresponding parts throughout:

FIG. 1A illustrates a design document and included revision block;

FIG. 1B illustrates a revision block of FIG. 1A;

FIG. 2 schematically illustrates a hardware and software environment in accordance with one or more embodiments of the invention; and

FIG. 3 is a flowchart illustrating the distribution of a design document in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

A representation of a revision block for a design document is captured. The representation (independently from the design document) is then distributed to consumers/applications using a web service.

Hardware and Software Environment

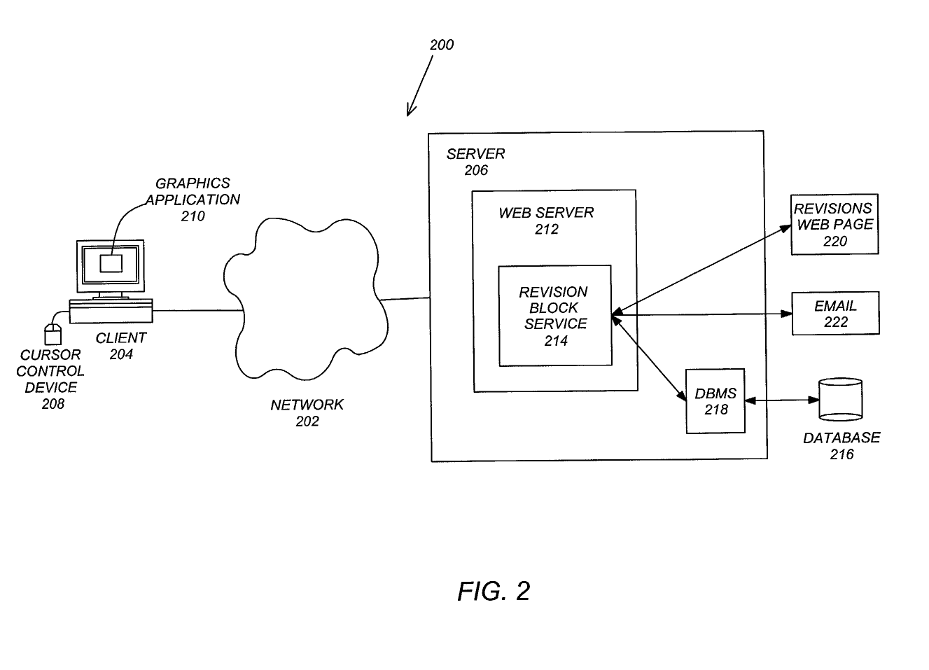

FIG. 2 schematically illustrates a hardware and software environment in accordance with one or more embodiments of the invention, and more particularly, illustrates a typical distributed computer system 200 using a network 202 to connect client computers 204 to server computers 206. A typical combination of resources may include a network 202 comprising the Internet, local area networks (LANs), wide area networks (WANs), or the like, clients 204 that are personal computers or workstations, and servers 206 that are personal computers, workstations, minicomputers, or mainframes. Additionally, both client 204 and server 206 may receive input (e.g., cursor location input) and display a cursor in response to an input device such as cursor control device 208.

A network 202 such as the Internet connects clients 204 to server computers 206. Clients 204 may execute a client application such as graphics application 210 and communicate with server computers 206 executing Web servers 212. Such a graphics application 210 is typically a program utilized to create, edit, and/or view design documents such as CAD drawings. The Web server 212 is typically a program such as Microsoft's Internet Information Server.

Web server 212 may host a revision block service 214. As used herein, the terms revision block service 214 and distributed revision block service 214 are used interchangeably. The revision block service 214 may communicate with clients 204 in a variety of manners (e.g., using email). Additionally, the revision block service 214 may be configured to communicate with other servers 206 and/or web pages maintained on such servers 206. Further, the revision block service 214 may communicate and manipulate data in database 216 through a database management system (DBMS) 218.

Generally, these components 208-218 all comprise logic and/or data that is embodied in or retrievable from a device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

Software Embodiments

The revision block service 214 may be utilized to distribute a representation of a revision block 100 to one or more project participants (e.g., clients 204). The revision block service 214 or graphics application 210 automatically captures a representation (e.g., an XML representation) of a design document's 102 revision block 100 and distributes the block 100 to a variety of consumers via a web service (e.g., the revision block service 214). Further, as additional revisions are added to the revision block 100, the representation is updated and redistributed.

A designer may modify a design document 102 using graphics application 210. The changes cause the revision block 100 to be updated. A representation of the revision block 100 is then created and transmitted to the revision block service 214. The revision block service 214 may then transmit the representation 100 to a Web site 220 used to track revisions for a project, a database 216 used for document management, and/or in one or more emails 222 to relevant project participants.

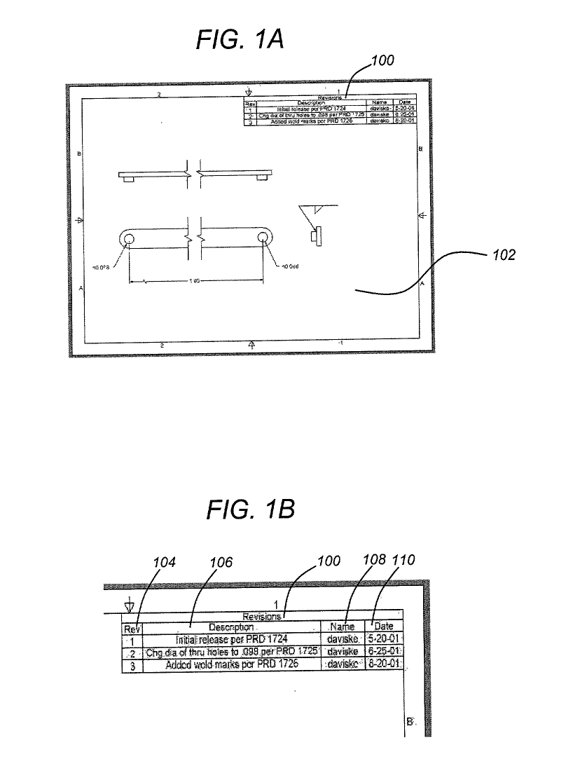

A specific example of the utilization of the revision block service 214 can be described with reference to FIG. 1 and FIG. 2 as follows. A designer may add a weld symbol to a drawing 102 and the revision block 100 is updated. Once the drawing is saved, the following XML representation of the revision block may be created:

<?xml version=“1.0” encoding=“utf-8” ?>
−<RevisionBlock

xmlns:xsi=“http://www.w3.org/2001/XMLSchema-instance”
xmlns:xsd=“http://www.w3.org/2001/XMLSchema”
xmlns=“http://tempur1.org/XSDSchema1.xsd”>

−<Revisions>

−<Revision>

<Date>2001-05-20-07:00</Date>
<RevisedBy>daviske</RevisedBy>
<Description>Initial Release per PRD 1724</Description>
<Number>1</Number>

</Revision>
−<Revision>

<Date>2001-06-25-07:00</Date>
<RevisedBy>daviske</RevisedBy>
<Description>Chg dia of thru holes to .125 per PRD

1725</Description>

<Number>2</Number>

</Revision>
−<Revision>

<Date>2001-08-20-07:00</Date>
<RevisedBy>daviske</RevisedBy>
<Description>Added weld marks per PRD 1726</Description>
<Number>3</Number>

</Revision>

</Revisions>
<Title>REVISIONS</TITLE>

</RevisionBlock>

As illustrated in the above XML, each row in the revision block 100 is represented by a “Revision” element. For example, each revision within the revision block 100 may be identified/enclosed within the <Revision> and </Revision> tags. Within each revision element, sub-elements may be used to describe/define the revision. For example, in the above illustrated XML, each revision element is defined by the date of the revision 110 (enclosed within the <Date> and </Date> tags), the name 108 of the user that performed the revision (enclosed within the <RevisedBy> and </RevisedBy> tags), a description 106 of the revision (enclosed within the <Description> and </Description> tags), and a revision number 104 (enclosed within the <Number> and </Number> tags). Additional revision elements may be added by enclosing an additional element between appropriate tags within a revision element.

The structure for the representation of the revision block 100 may be set forth in an XML schema that can be used to validate the format of the XML representation created by an application 210. For example, the above XML identifies the appropriate schema to use for validation (i.e., the schema available at “tempurl.org/XSDSchema1.xsd”). Alternatively, since a revision block 100 may be customized depending on the documentation needs of a particular user/organization, the XML may be generated dynamically and not validated by a schema.

Once the XML representation of the revision block 100 is created, the representation is transmitted to the revision block service 214 via the Internet 202. The revision block service 214 then distributes the representation by sending the XML representation to a web site 220 used to track revisions for the project, to a database 216 used for document management, and/or in emails 222 to the project lead and to the designer.

Advantages

Embodiments of the invention provide many advantages. For example, the technology utilizes existing revision blocks 100 and is available in any design application (e.g. CAD application) running on a computer with a network/Internet connection. Also, since the revision block 100 is transmitted in an XML representation, recipients may view, analyze, and manipulate the representation independently from the design document 102. Thus, consumers of the design document 102 can be notified of changes to the design without having to refer to the design document 102 directly. This ability can be provided transparently to traditional CAD designers who will be able to continue the use of their existing revision blocks 100. Further, by transmitting an XML representation of the revision block 100 instead of transferring the entire document 102 containing the revision block 100, the transfer occurs quickly and efficiently.

Design Document Distribution Flow

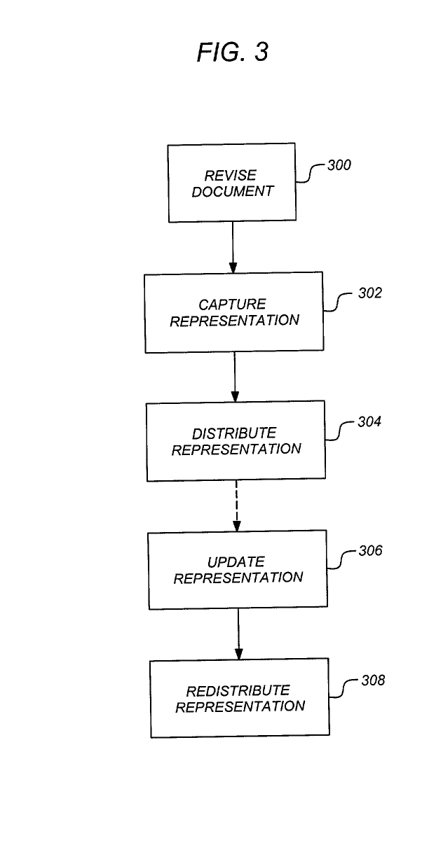

FIG. 3 is a flowchart illustrating the distribution of a design document 102 in accordance with one or more embodiments of the invention. At step 300, a consumer revises a design document 102. At step 302, a representation of the revision block 100 of the design document 102 is captured. The representation may be captured when the design document 102 is updated or saved. Alternatively, the representation may be captured when specified by an application/consumer and/or whenever a revision block 100 is updated/saved. Additionally, the representation may be captured transparently (to a designer) and automatically. As described above, the revision block 100 documents a history of changes to the design document 102, may be an XML representation, and/or may comprise a table of various design document properties that may be customized to meet documentation needs of an organization.

At step 304, the representation of the revision block 100 is distributed via a network service (e.g., a revision block service 214). The distribution may be to a consumer of the design document 102 such that the consumer is notified of changes in the design document 102 without having to refer to the design document 102 directly. Step 304 may comprise transmitting the representation to a network service that transmits the representation to a web site used to track revisions for a project, to a database used for document management, and in one or more emails to a design document 102 consumer.

The process may be complete after step 304. However, embodiments may also provide for updating the representation as additional revisions are added to the revision block 100 at step 306. Subsequently, the updated representation may be redistributed as described above at step 308.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for distributing design document changes comprising:
capturing a representation of a revision block of a design document, wherein the revision block documents a history of changes to the design document; and
distributing the representation via a network service.

2. The method of claim 1, wherein the representation is an extensible markup language (XML) representation.

3. The method of claim 1, wherein the revision block comprises a table of various design document properties.

4. The method of claim 3, wherein the design document properties are customized to meet documentation needs of an organization.

5. The method of claim 1, wherein the representation is automatically captured.

6. The method of claim 1, wherein the representation is captured transparently to a designer.

7. The method of claim 1, wherein the representation is distributed to a consumer of the design document such that the consumer is notified of changes in the design document without having to refer to the design document directly.

8. The method of claim 1, further comprising:
updating the representation as additional revisions are added to the revision block; and
redistributing the representation.

9. The method of claim 1, wherein the distributing comprises transmitting the representation to the network service via a network, wherein the network service transmits the representation:
to a web site used to track revisions for a project;
to a database used for document management; and
in an email to a design document consumer.

10. An apparatus for distributing design document changes in a computer system comprising:
(a) a computer having a memory;
(b) an application executing on the computer, wherein the application is configured to:
(i) capture a representation of a revision block of a design document into the memory, wherein the revision block documents a history of changes to the design document; and
(ii) distribute the representation via a network service.

11. The apparatus of claim 10, wherein the representation is an extensible markup language (XML) representation.

12. The apparatus of claim 10, wherein the revision block comprises a table of various design document properties.

13. The apparatus of claim 12, wherein the design document properties are customized to meet documentation needs of an organization.

14. The apparatus of claim 10, wherein the representation is automatically captured.

15. The apparatus of claim 10, wherein the representation is captured transparently to a designer.

16. The apparatus of claim 10, wherein the representation is distributed to a consumer of the design document such that the consumer is notified of changes in the design document without having to refer to the design document directly.

17. The apparatus of claim 10, wherein the application is further configured to:
update the representation as additional revisions are added to the revision block; and
redistribute the representation.

18. The apparatus of claim 10, wherein the application distributes the representation by transmitting the representation to the network service via a network, wherein the network service transmits the representation:
to a web site used to track revisions for a project;
to a database used for document management; and
in an email to a design document consumer.

19. An article of manufacture comprising a program storage medium readable by a computer and embodying logic executable by the computer that causes the computer to distribute design document changes, wherein the logic comprises:
capturing a representation of a revision block of a design document, wherein the revision block documents a history of changes to the design document; and
distributing the representation via a network service.

20. The article of manufacture of claim 19, wherein the representation is an extensible markup language (XML) representation.

21. The article of manufacture of claim 19, wherein the revision block comprises a table of various design document properties.

22. The article of manufacture of claim 21, wherein the design document properties are customized to meet documentation needs of an organization.

23. The article of manufacture of claim 19, wherein the representation is automatically captured.

24. The article of manufacture of claim 19, wherein the representation is captured transparently to a designer.

25. The article of manufacture of claim 19, wherein the representation is distributed to a consumer of the design document such that the consumer is notified of changes in the design document without having to refer to the design document directly.

26. The article of manufacture of claim 19, wherein the logic further comprises:
updating the representation as additional revisions are added to the revision block; and
redistributing the representation.

27. The article of manufacture of claim 19, wherein the logic for distributing comprises logic for transmitting the representation to the network service via a network, wherein the network service transmits the representation:
to a web site used to track revisions for a project;
to a database used for document management; and
in an email to a design document consumer.
